(19) United States
(12) Patent Application Publication
(10) Pub. No.: US 2025/0005463 A1
(43) Pub. Date: Jan. 2, 2025

(54) INFORMATION PROCESSING DEVICE, CONTROL METHOD, AND STORAGE MEDIUM

(71) Applicant: NEC CORPORATION, Minato-ku, Tokyo (JP)

(72) Inventors: Naoto Ohsaka, Tokyo (JP); Tatsuya Matsuoka, Tokyo (JP)

(73) Assignee: NEC CORPORATION, Minato-ku, Tokyo (JP)

(21) Appl. No.: 18/707,908

(22) PCT Filed: Mar. 18, 2022
(86) PCT No.: PCT/JP2022/012763

§ 371 Date: May 7, 2024

(51) Int. Cl. G06Q 10/04

(52) U.S. Cl. CPC G06Q 10/04

(57) ABSTRACT

The information processing device 1X mainly includes a solution determination means 15X and a display control means 162X. The solution determination means 15 determines, based on condition information regarding conditions of an optimization problem and constraint relaxation information regarding a relaxation of a constraint condition, a solution of the optimization problem in accordance with a degree of the relaxation of the constraint condition. The display control means 162X displays, on a display device, relation information indicating a relation between the degree of the relaxation of the constraint condition and an objective function value of the solution corresponding to the degree of the relaxation.

### TECHNICAL FIELD

The present disclosure relates to a technical field of an information processing device, a control method, and a storage medium for performing processing related to an optimization problem.

### BACKGROUND

There are known systems configured to calculate the solution of an optimization problem. For example, Patent Literature 1 discloses an electronic transaction mediation system configured to generate a plurality of candidates of combinations of traders and customers to meet desired trading conditions of both the traders and the customers at the same time. Further, Patent Literature 2 discloses an optimization system capable of performing rematching by changing some terms of transaction after determining (matching) a combination between sellers and buyers to meet the terms of transaction desired by sellers and the buyer regarding goods to be traded, such as trading volume and transaction price.

### CITATION LIST

### Patent Literature

Patent Literature 1: WO2002/027575
Patent Literature 2: WO2021/001977

### SUMMARY

### Problem to be Solved

When a solution of an optimization problem is obtained by optimization, the solution satisfies formulated constraint conditions. On the other hand, there are cases where the user can tolerate a solution where some constraint conditions are not strictly satisfied.

In view of the issues described above, one object of the present invention is to provide an information processing device, a control method, and a storage medium capable of suitably presenting information in consideration of relaxation of a constraint condition.

### Means for Solving the Problem

In one mode of the control device, there is provided an information processing device including:
a solution determination means configured to determine, based on condition information regarding conditions of an optimization problem and constraint relaxation information regarding a relaxation of a constraint condition, a solution of the optimization problem in accordance with a degree of the relaxation of the constraint condition; and
a display control means configured to display, on a display device, relation information indicating a relation between the degree of the relaxation of the constraint condition and an objective function value of the solution corresponding to the degree of the relaxation.

In one mode of the control method, there is provided a control method executed by a computer, the control method including:
determining, based on condition information regarding conditions of an optimization problem and constraint relaxation information regarding a relaxation of a constraint condition, a solution of the optimization problem in accordance with a degree of the relaxation of the constraint condition; and
displaying, on a display device, relation information indicating a relation between the degree of the relaxation of the constraint condition and an objective function value of the solution corresponding to the degree of the relaxation.

In one mode of the storage medium, there is provided a storage medium storing a program executed by a computer, the program causing the computer to:
determine, based on condition information regarding conditions of an optimization problem and constraint relaxation information regarding a relaxation of a constraint condition, a solution of the optimization problem in accordance with a degree of the relaxation of the constraint condition; and
display, on a display device, relation information indicating a relation between the degree of the relaxation of the constraint condition and an objective function value of the solution corresponding to the degree of the relaxation.

### Effect

An example advantage according to the present invention is to suitably present information considering the relaxation of a constraint condition.

### BRIEF DESCRIPTION OF THE DRAWINGS

FIG. 1 It illustrates the configuration of an optimization system in a first example embodiment.

FIG. 2 It illustrates the hardware configuration of the information processing device.

FIG. 3 It is an example of a functional block of a processor related to an optimization process.

FIG. 4 It is an example of a flowchart showing an outline of the optimization process in the first example embodiment.

FIG. 5 It is a first display example of the constraint relaxation designation screen image.

FIGS. 6A and 6B FIG. 6A is a second display example of the constraint relaxation designation screen image. FIG. 6B is a third display example of the constraint relaxation designation screen image.

FIG. 7 It is a graph showing the relation between the variable x and the penalty value for the constraint condition (a).

FIG. 8 It illustrates a display example of the penalty value/objective function value relation screen image.

FIG. 9 It illustrates a display example of the constraint relaxation status comparison screen image.

FIG. 10 It illustrates a configuration of an optimization system in a second example embodiment.

FIG. 11 It is a functional block diagram of an information processing device according to a third example embodiment.

FIG. 12 It illustrates an example of a flowchart showing a processing procedure of the information processing device in the third example embodiment.

### EXAMPLE EMBODIMENTS

Hereinafter, example example embodiments regarding an information processing device, a control method, and a storage medium will be described with reference to the drawings.

### First Example Embodiment

### (1) System Configuration

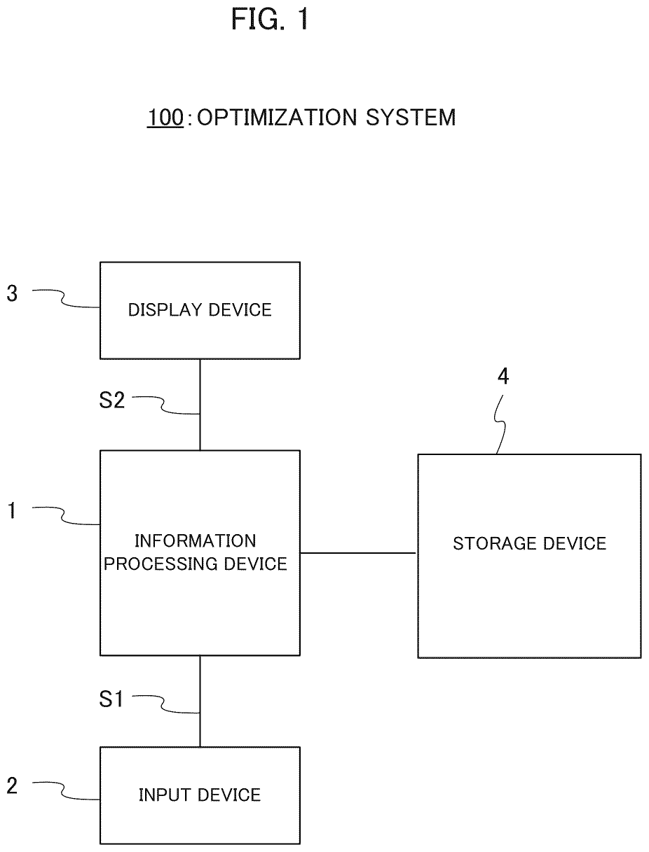

FIG. 1 shows a configuration of an optimization system 100 according to a first example embodiment. The optimization system 100 mainly includes an information processing device 1, an input device 2, a display device 3, and a storage device 4.

The information processing device 1 performs optimization processing that is processing related to optimization in the specified optimization problem. The optimization process includes a process of receiving a designation related to relaxation of constraint conditions of the optimization problem and a process of displaying information on solutions of the optimization problem in accordance with the degree of relaxation of constraint conditions. It should be noted that examples of the optimization problem include a problem of determining a combination between sellers and buyers regarding target commodities of transactions (and a transportation schedule for the target commodities), a problem of determining working shifts of employees, and any other combination optimization problem. Examples of the target commodities of transaction described above include fuels such as LNG, steel, machinery, electronics, fibers, chemicals, medical-related goods, food, and any other commodity.

Further, the information processing device 1 performs data communication with the input device 2, the display device 3, and the storage device 4 through a communication network or through wireless or wired direct communication.

The input device 2 is an interface for receiving an input by a user, and examples thereof include a touch panel, a button, a voice input device, and the like. The input device 2 supplies input information “S1” generated based on the input from the user to the information processing device 1. In this case, for example, the information processing device 1 generates various types of information to be stored in the storage device 4 based on the input information S1 supplied from the input device 2, and identifies conditions specified by the user with respect to the optimization process.

The display device 3 is, for example, a display, a projector, or the like, and displays predetermined information on the basis of display information “S2” supplied from the information processing device 1.

The storage device 4 is a memory for storing various information necessary for optimization processing. For example, the storage device 4 stores condition information indicating conditions of the optimization problem to be solved by the information processing device 1. The condition information contains information regarding constraint conditions before relaxation. For example, if the problem of determining the combination between sellers and buyers regarding the target commodities of transactions is set as an optimization problem to be solved by the information processing device 1, the condition information includes information (including the desired conditions of each seller regarding the place of delivery, delivery period, amount of transactions, and price) regarding the sellers of the target commodities of transactions, information (including the desired conditions of each buyer regarding the place of delivery, delivery period, amount of transactions, and price) regarding the buyers of the target commodities of transactions, and the like.

The storage device 4 may be an external storage device such as a hard disk connected to or embedded in the information processing device 1, or may be a storage medium such as a flash memory. The storage device 4 may be a server device that performs data communication with the information processing device 1. In this case, the storage device 4 may be configured by a plurality of server devices.

The configuration of the optimization system 100 shown in FIG. 1 is an example, various changes may be made to the configuration. For example, the input device 2 and the display device 3 may be configured integrally. In this case, the input device 2 and the display device 3 may be configured as a tablet terminal that is integrated with the information processing device 1. Further, the information processing device 1 may be configured by a plurality of devices. In this case, the plurality of devices constituting the information processing device 1 performs transmission and reception of information necessary for executing preassigned processing among the plurality of devices.

### (2) Hardware Configuration of Information Processing Device

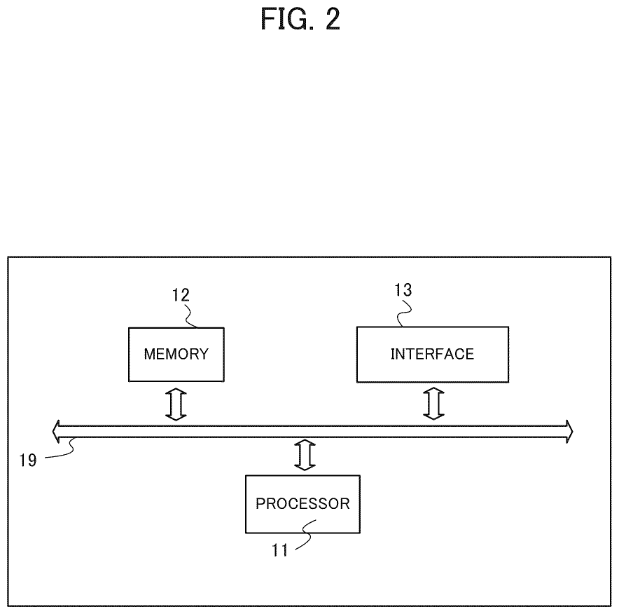

FIG. 2 shows a hardware configuration of the information processing device 1. The information processing device 1 includes a processor 11, a memory 12, and an interface 13 as hardware. The processor 11, the memory 12 and the interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories and non-volatile memories such as a RAM (Random Access Memory) and a ROM (Read Only Memory). Further, a program for the information processing device 1 to execute various kinds of process is stored in the memory 12. The memory 12 is used as a working memory to temporarily store information and the like acquired from the storage device 4. The memory 12 may function as a storage device 4. The storage device 4 may function as the memory 12 of the information processing device 1. The program executed by the information processing device 1 may be stored in a storage medium other than the memory 12.

The interface 13 is one or more interfaces for electrically connecting the information processing device 1 to other devices. Examples of the interfaces include a wireless interface, such as a network adapter, for transmitting and receiving data to and from other devices wirelessly, and a hardware interface, such as a cable, for connecting to other devices.

The hardware configuration of the information processing device 1 is not limited to the configuration shown in FIG. 2. For example, the information processing device 1 may include at least one of the input device 2 and/or the display device 3. Further, the information processing device 1 may be connected to or incorporate a sound output device such as a speaker.

### (3) Overview of Optimization Process

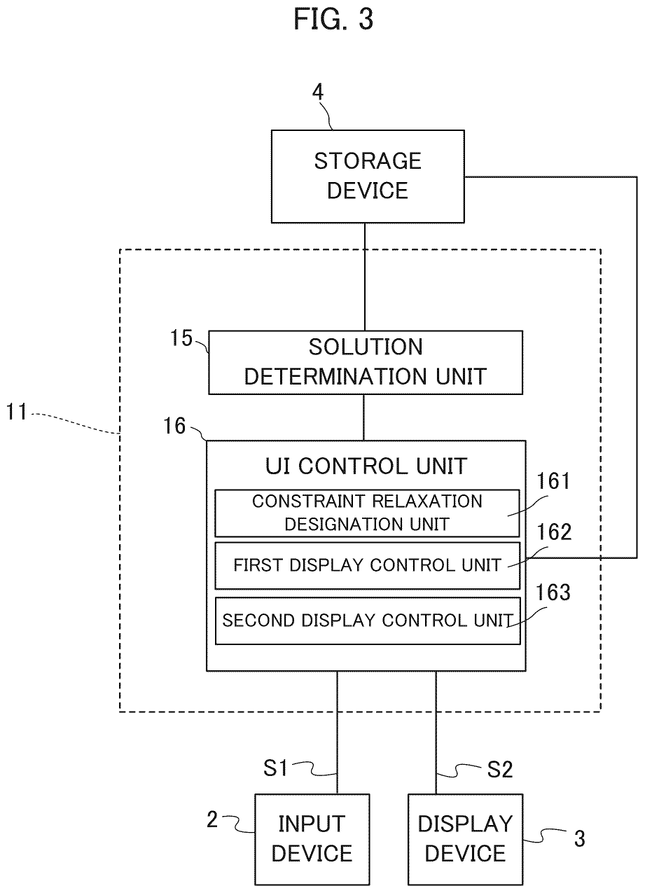

FIG. 3 is an example of functional blocks of the processor 11 relating to optimization processing. The processor 11 functionally includes a solution determination unit 15 and a UI (User Interface) control unit 16. Further, in FIG. 3, the blocks to exchange data with each other are connected to each other by a solid line, but the combinations of the blocks to exchange data with each other is not limited to FIG. 3. The same applies to the drawings of other functional blocks described below.

The solution determination unit 15 determines one or more solutions of the optimization problem. In this instance, the solution determination unit 15 determines the solutions of the optimization problem based on the condition information regarding the optimization problem stored in the storage unit 4 and the information supplied from the constraint relaxation designation unit 161 of the UI control unit 16. In this case, as will be described later, the information supplied from the constraint relaxation designation unit 161 includes information regarding types of constraint conditions the relaxation of which is acceptable, information regarding the acceptable range of the relaxation, and information specifying the weight for the penalty for the relaxation. Therefore, while accepting the relaxation of constraint conditions within the range specified by the user, the solution determination unit 15 calculates a plurality of optimization solutions according to the degrees of the relaxation. The solution determination unit 15 supplies data (also referred to as “solution data”) representing the solutions calculated according to the degrees of relaxation of the constraint conditions to the UI control unit 16.

The solution determination unit 15 may determine the solutions of the optimization problem based on an arbitrary optimization method (optimization solver). For example, when solving a problem of determining a combination of sellers and buyers regarding the target commodities of transactions, the solution determination unit 15 formulates the problem as an integer programming problem by regarding the problem as a single combination optimization problem. The solution determination unit 15 obtains a solution of the formulated integer programming problem by performing the processing equivalent to a typical application program (e.g., IBM ILOG CPLEX, Gurobi Optimizer, SCIP). A determination method of the sellers, buyers, the ships to be used, and each navigation period of the ships by setting an integer programming problem is, for example, disclosed in Patent Literature 2 and the like.

The UI control unit 16 receives the user input and controls the display of the information to be viewed by the user. In this case, based on the input information S1 supplied from the input device 2, the UI control unit 16 accepts the designation from the user regarding relaxation of the constraint conditions, or performs display control of the display device 3 by supplying the display information S2 generated based on the solution data generated by the solution determination unit 15 to the display device 3.

The UI control unit 16 functionally includes a constraint relaxation designation unit 161, a first display control unit 162, and a second display control unit 163.

The constraint relaxation designation unit 161 receives the designation from the user regarding the relaxation of the constraint conditions. In the present exemplary example embodiment, the constraint relaxation designation unit 161 receives user input specifying an acceptable type of a constraint condition the relaxation of which is acceptable, the acceptable relaxation range (also referred to as “relaxation range”), and the weight (also referred to as “penalty weight”) for penalty for the relaxation of the constraint condition. The “penalty weight” here refers to the degree of penalty for the relaxation of the constraint condition, and is a coefficient used to calculate a penalty value, which is an index value that comprehensively indicates the degree of relaxation of the constraint condition. The constraint relaxation designation unit 161 supplies information (also referred to as “constraint relaxation information”) on the relaxation of the constraint condition identified based on user input to the solution determination unit 15. Thereafter, based on the constraint relaxation information generated by the constraint relaxation designation unit 161 and the condition information stored in the storage device 4, the solution determination unit 15 performs the optimization a plurality of times using penalty values, and determines a plurality of solutions in accordance with the penalty values. The method of determining the penalty value will be described later.

The first display control unit 162 acquires solution data indicating a solution corresponding to a penalty value from the solution determination unit 15 and then, based on the solution data, displays on the display device 3 information indicating the relation between the penalty value and the value (also referred to as “objective function value”) of the objective function to be maximized or minimized in the optimization. Hereafter, the screen image for displaying information (relational information) indicating the relation between the penalty value and the objective function value is also referred to as “penalty value/objective function value relation screen image”. The display example of the penalty value/objective function value relation screen image will be described later.

When any two sets of the penalty value and the objective function value are specified based on the user input in the penalty value/objective function value relation screen image, the second display control unit 163 causes the display device 3 to display information for comparing the relaxation status of constraint condition(s) between the solutions corresponding to the specified two sets. Hereinafter, a screen image for comparing the relaxation status of the constraint conditions between the solutions corresponding to the specified two sets is also referred to as “constraint relaxation status comparison screen image”. The display example of the constraint relaxation status comparison screen image will be described later.

Each component of the solution determination unit 15, the constraint relaxation designation unit 161, the first display control unit 162, and the second display control unit 163 described in FIG. 3 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

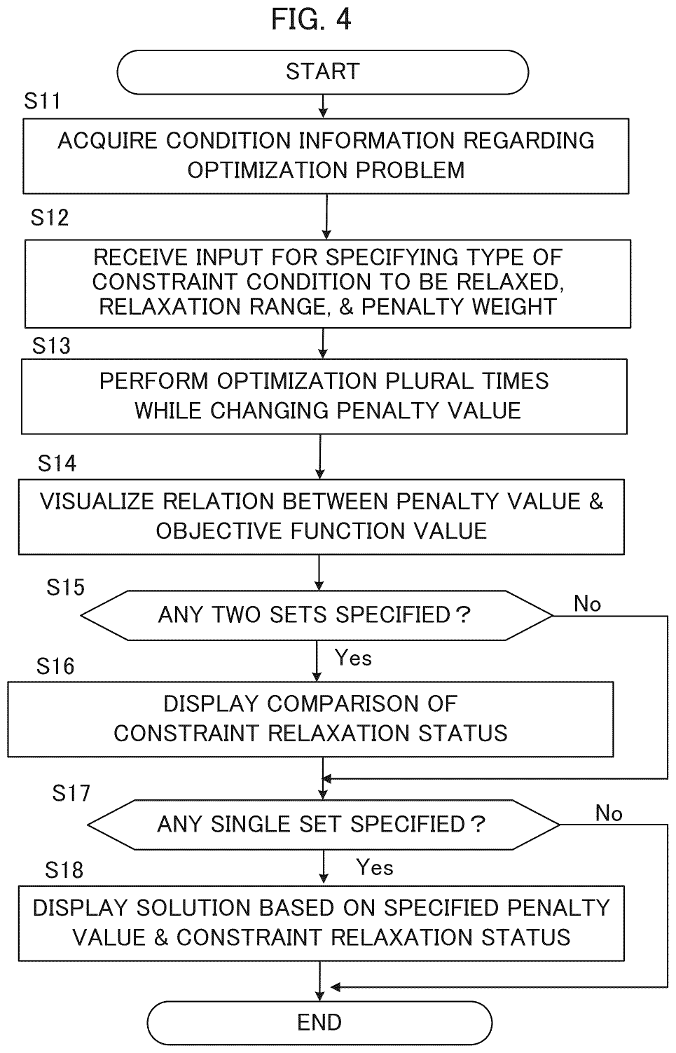

FIG. 4 is an example of a flowchart showing an outline of the optimization process in the first example embodiment.

First, the information processing device 1 acquires condition information regarding the optimization problem to be optimized from the storage device 4 or the like (step S11). Next, the information processing device 1 receives an input that specifies a target constraint condition type of the relaxation, the relaxation range thereof, and the penalty weight thereof (step S12).

Then, on the basis of the constraint relaxation information generated by the input received at step S12, the information processing device 1 executes the optimization a plurality of times while changing the penalty value which is the degree of relaxation of a constraint condition (step S13). In this case, for example, the information processing device 1 performs optimizations with a plurality of penalty values determined in advance, respectively, and thereby generates solutions of the optimizations for the plurality of penalty values.

Next, based on the solution data generated at step S13, the information processing device 1 causes the display device 3 to display a penalty value/objective function value relation screen image in which the relation between the penalty value and the objective function value is visualized (step S14). Then, the information processing device 1 determines whether or not any two sets are specified from the sets of the penalty value and the objective function value displayed on the penalty value/objective function value relation screen image (step S15). Upon determining that any two sets have been specified (step S15; Yes), the information processing device 1 displays the penalty value/objective function value relation screen image for comparing the relaxation status of the constraint condition between the solutions corresponding to the specified two sets on the display device 3 (step S16).

On the other hand, upon determining that any two sets has not been specified (step S15; No), the information processing device 1 determines whether or not any one set is specified from the set of the penalty value and the objective function value displayed on the penalty value/objective function value relation screen image (step S17). Upon determining that any single set is specified (step S17; Yes), the information processing device 1 displays the solution corresponding to the specified set and the relaxation status of the constraint condition in the solution on the display device 3 (step S18). On the other hand, upon determining that none of the sets of the penalty value and the objective function value displayed on the penalty value/objective function value relation screen image is specified (step S17; No), the information processing device 1 terminates the processing of the flowchart.

A supplementary explanation is given here on the effect of the relaxation of a constraint condition. For example, when a decision maker uses this system in the transactions, with reference to the penalty value/objective function value relation screen image and the constraint relaxation status comparison screen image, the decision maker can grasp the situation on the assumption that the decision maker relaxes the constraint condition, and therefore obtain a bargaining chip for affecting the transaction partner. In another example, it may lead to an improvement in the objective function value as compared to the case where a single optimization is performed without relaxing any constraint condition. In yet another example, when a feasible solution is not found (impracticable) in the optimization by the solution determination unit 15, a feasible solution can be obtained by including the relaxation of a constraint condition in the options.

### (4) Generating Constraint Relaxation Information

Next, a specific example of a method of generating the constraint relaxation information that is executed by the constraint relaxation designation unit 161 will be described.

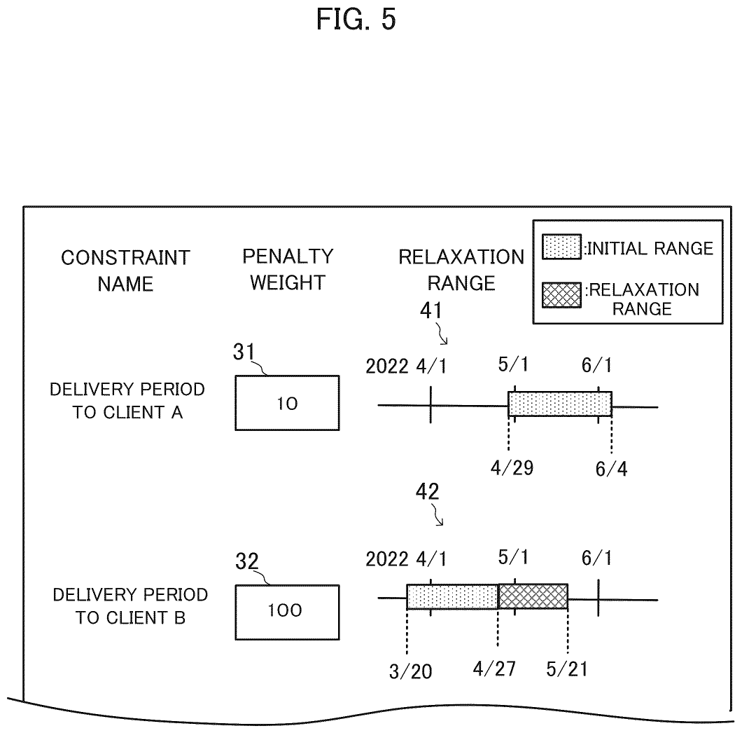

FIG. 5 is a first display example of an input screen image (also referred to as “constraint relaxation designation screen image”) for specifying a constraint relaxation. The first display example shows a display example when constraint conditions to be relaxed are specified as a continuous range such as a time period.

The constraint relaxation designation unit 161 generates the display information S2 for displaying the constraint relaxation designation screen image based on the condition information, and transmits the generated display information S2 to the display device 3 via the interface 13 to display the constraint relaxation designation screen image on the display device 3. For example, the condition information stored in the storage device 4 includes information in which each type of the constraint conditions is associated with the constraint name, the initial value of the penalty weight, and the initial range (constrained range) indicating the content of the constraint before relaxation, and the constraint relaxation designation unit 161 generates the display information S2 of the constraint relaxation designation screen image by referring to the condition information.

The constraint relaxation designation screen image relating to the first display example includes display fields corresponding to each item of “constraint name”, “penalty weight”, and “relaxation range”. The item “constraint name” indicates the name of a candidate for a target constraint condition (in other words, a potential constraint condition to be relaxed) of the relaxation. Here, “delivery period to client A” and “delivery period to client B” are listed in the display field of the item “constraint name”.

The item “penalty weight” indicates the penalty weights to be set for the constraint conditions of the constraint names displayed in the display field of the item “constraint name”, and the weight designation fields 31 and 32 are provided in the display field of the item “penalty weight”. The weight designation fields 31 and 32 are input fields in which the user can specify arbitrary numerical values as the penalty weights by the input device 2, respectively. The initial values of the penalty weights may be displayed in advance in the weight designation fields 31 and 32.

The item “relaxation range” indicates the acceptable relaxation statuses of the constraint conditions of the constraint names displayed in the display fields of the item “constraint name”, and the graphs 41 and 42 are displayed in the display fields of the item “relaxation range”, respectively. The graphs 41 and 42 show the initial ranges of the constraint conditions indicated by the condition information, respectively. In addition, graph 42 shows the relaxed range of the constraint condition specified by user input in addition to the initial range. For example, the constraint relaxation designation unit 161 receives the designation of the relaxation range by detecting an operation of dragging and dropping the right end or left end of the initial range to a position corresponding to an acceptable date or the like. For example, in the case of the graph 42, the constraint relaxation designation unit 161 detects the operation of dragging and dropping the right end of the initial range to the position of May 21, and thereby sets the relaxation range from the start point that is the end point of the initial range (April 27) to the end point that is May 21.

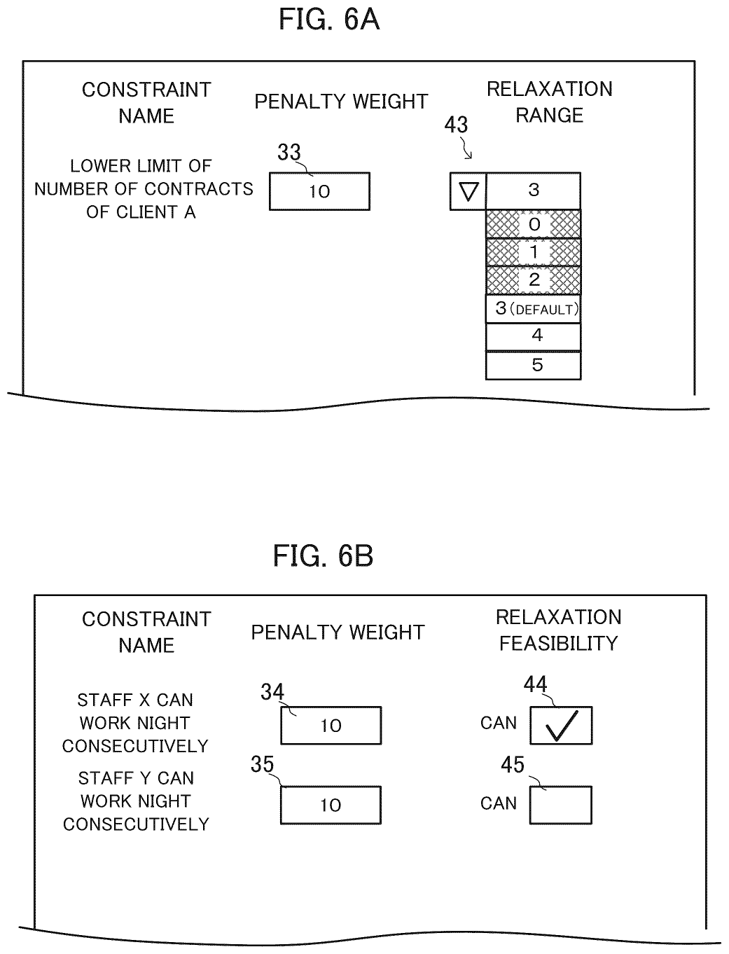

FIG. 6A is a second display example of the constraint relaxation designation screen image. The second display example is a display example in which the candidates for target constraint conditions of the relaxation are specified by discrete numerical values.

In the second display example, “lower limit of the number of contracts of client A” is displayed in the display field of the item “constraint name”. In the the display field of the item “penalty weight”, there is provided a weight designation field 33 which is an input field of the penalty weight to be set for the constraint condition “lower limit of the number of contracts of client A”. In the display field of the item “relaxation range”, there is provided a relaxation range designation field 43 which is an input field for specifying the relaxation range for the above-described constraint condition.

The relaxation range designation field 43 is an input field in a pull-down menu format as an example, and displays values (discrete values) each settable as a lower limit of the number of contracts of the client A in a selectable way. In addition, the initial value of the constraint condition “lower limit of the number of contracts of client A” is “3”, and the values “0”, “1”, and “2”, which are less constrained than the initial value, are highlighted in the relaxation range designation field 43. For example, if “1” is selected in the relaxation range designation field 43, once and twice as the number of contracts of the client A will be additionally allowed. In this case, the range where once and twice as the number of contracts of the business partner A corresponds to the relaxation range.

FIG. 6B is a third display example of the constraint relaxation designation screen image. The third display example is a display example for specifying whether or not each target constraint condition of relaxation can be omitted.

According to the third display example, “staff X can work night consecutively” and “staff Y can work night consecutively” are listed in the display field of the item “constraint name”. Then, in the display field of the item “penalty weight”, there are provided weight designation fields 34 and 35 which are input fields of the penalty weights to be set for these constraint conditions, respectively. Further, in the display field of the item “relaxation feasibility”, there are provided checkboxes 44 and 45 as an input field for specifying whether or not each of these constraint conditions can be relaxed (here omitted). In the example shown in FIG. 6B, since the check box 44 is checked, it is specified that the constraint condition “staff X can work night consecutively” can be omitted by relaxation.

In this way, the constraint relaxation designation unit 161 displays various constraint conditions as candidates for acceptable target constraint conditions of relaxation, and can receive the designation of the penalty weight and the relaxation range regarding a constraint condition specified by the user as an acceptable target constraint condition of relaxation.

### (5) Calculation of Penalty Value Based on Penalty Weight

Next, a supplementary description will be given of the method of calculating the penalty value based on the penalty weigh with specific examples.

Here, variables to be obtained as a solution in the optimization problem are assumed to be “x” (continuous value), “y” (integer value), and “z” (binary value indicating 0 or 1), and the following constraint conditions (a) to (c) are included in the condition information.

$$( a ) ( b ) ( c ) \qquad 4 ≦ x ≦ 103 ≦ y ≦ 5 z = 0$$

The objective function is assumed to be set as the sum (x+y+z) of x, y, and z as follows, and the determination of the solution (x, y, z) of the optimization is made so that the objective function value is maximized or minimized (here, maximized).

Max(x+y+z)

Then, based on the user input in the constraint relaxation designation image screen, the constraint conditions (a) to (c) are assumed to be relaxed to the following conditions (a1) to (c1), respectively.

$$\begin{matrix}( a 1 ) & 1 ≦ x ≦ 13 \\ ( b 1 ) & 2 ≦ y ≦ 7 \\ ( c 1 ) & z = 0 or 1\end{matrix}$$

In addition, based on the user input on the constraint relaxation designation screen image, the penalty weights “pa,” “pb,” and “pc” for the constraint conditions (a) to (c) are set as follows, respectively.

Pa=4

Pb=2

Pc=10

In this situation, the penalty weights pa to pc are factors used in determining the penalty value. For example, the penalty weights are multiplied by the degree of deviation (degree of violation) of the determined solution from the original constraints (a) to (c). Then, the total value of the penalty weights multiplied by the degree of deviation for each constraint condition is calculated as the penalty value.

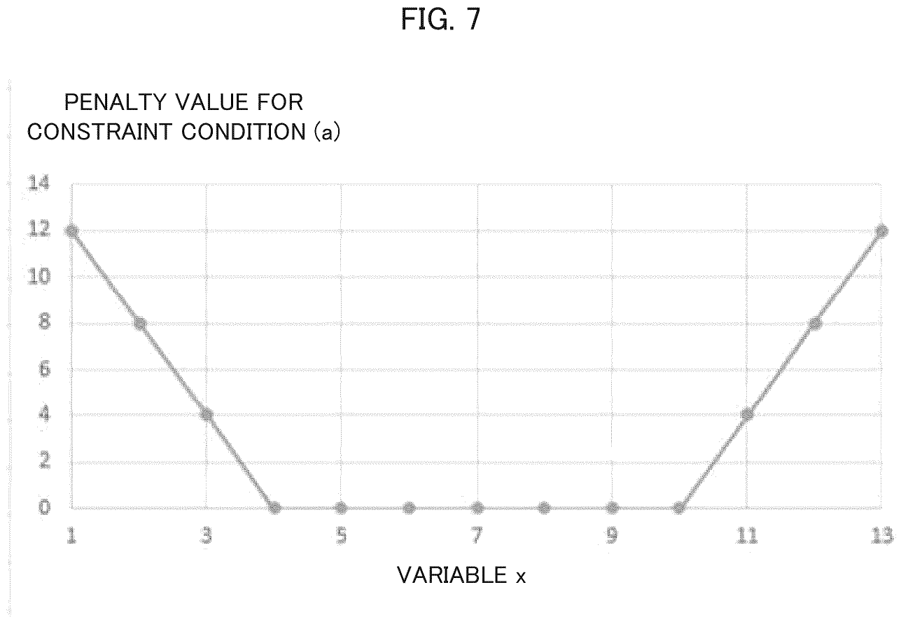

FIG. 7 is a graph showing the relation between the variable x and the penalty value for the constraint condition (a). As shown in FIG. 7, the penalty value for the constraint condition (a) becomes 0 as long as the constraint condition (a) is satisfied. On the other hand, if the constraint condition (a) is not satisfied and the condition is within the range (i.e. the relaxation range) that satisfies the condition (a1), the penalty value increases according to the penalty weight pa with an increase in the deviation (i.e., with increasing degree of violation) from the constraint condition (a).

For example, if the solution is (x, y, z)=(8, 4, 0), the penalty value is 0. On the other hand, if the solution is (x, y, z)=(13, 2, 1), the penalty value is

$$( 13 - 10 ) \cdot pa + ( 3 - 2 ) \cdot pb + ( 1 - 0 ) \cdot pc = 24 .$$

It is noted that (x, y, z)=(15, 5, 0) is omitted from the candidates for the solution because none of the constraint condition (a) and the condition (a1) after the relaxation are satisfied (i.e., it does not belong to any of the initial range and relaxation range).

### (6) Penalty Value/Objective Function Value Relation Screen Image

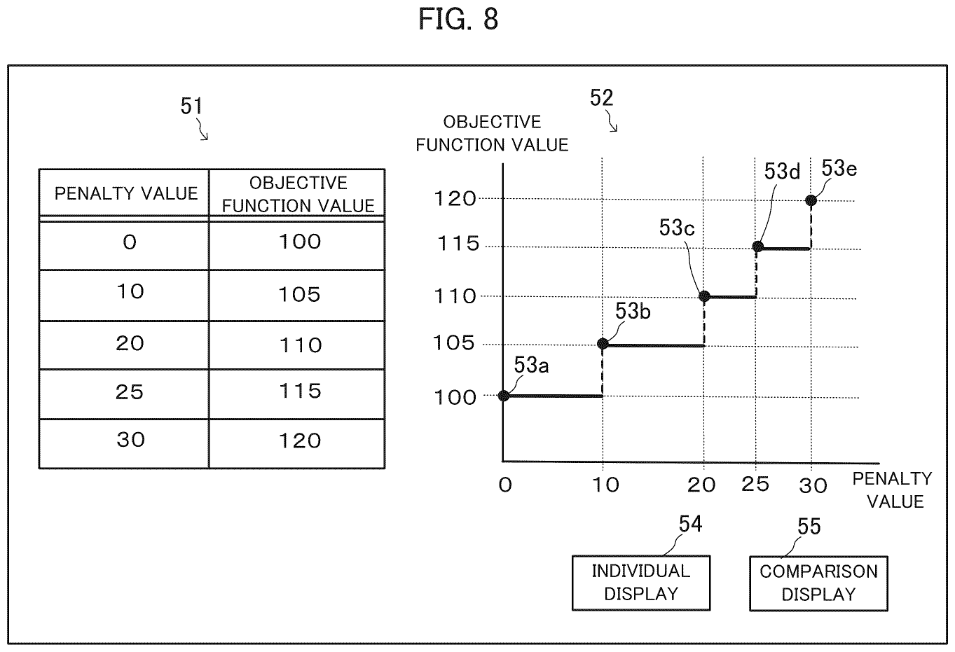

Next, the penalty value/objective function value relation screen image displayed by the first display control unit 162 will be specifically described. FIG. 8 shows a display example of the penalty value/objective function value relation screen image. The first display control unit 162 causes the display device 3 to display the penalty value/objective function value relation screen image by sending the display information S2 for displaying the penalty value/objective function value relation screen image to the display device 3 via the interface 13.

Here, on the penalty value/objective function value relation screen image, the first display control unit 162 displays a penalty value/objective function value table 51, which is a table having a plurality of records indicating the objective function value for each penalty value, a penalty value/objective function value graph 52, which is a graph showing the relation between the penalty value and the objective function value, an individual display button 54, and a comparison display button 55.

In this example, based on the constraint relaxation information and the condition information generated by the constraint relaxation designation unit 161, the solution determination unit 15 calculates the solutions which maximize the objective function value when the penalty value is set as “0”, “10”, “20”, “25”, and “30”, respectively. Then, the first display control unit 162 displays the penalty value/objective function value table 51 which associates the penalty values “0”, “10”, “20”, “25”, and “30” with the objective function values (100, 105, 110, 115, and 120) of the solutions corresponding to these penalty values, respectively. Similarly, the solution determination unit 15 displays a penalty value/objective function value graph 52 indicating the relation between the penalty values “0”, “10”, “20”, “25”, “30”, and the objective function values corresponding to these solutions. In addition, on the penalty value/objective function value graph 52, corresponding points 53a to 53e corresponding to respective records of the penalty value/objective function value table 51 are clearly indicated. There is such a trade-off relation between the penalty value and the objective function value that if one changes to an unfavorable value, then the other changes to a favorable value.

According to this display, the first display control unit 162 suitably visualizes the relation between the objective function value and the penalty value to thereby cause the user to accurately grasp the relation between the objective function value and the penalty value.

Each record in the penalty value/objective function value table 51 is selectable based on user input. Then, upon detecting that the individual display button 54 is selected while any one record of the penal value/objective function value table 51 is selected, the first display control unit 162 causes the display device 3 to display a screen image for displaying the solution and the constraint relaxation status by use of the penal value corresponding to the selected record in accordance with the process at step S18 in FIG. 4. On the other hand, upon detecting that the comparison display button 55 is selected while any two (which may be three or more) records of the penal value/objective function value table 51 are selected, the first display control unit causes the display device 3 to display a constraint relaxation status comparison screen image relating to the comparison display regarding the constraint relaxation status between the selected records in accordance with the process at step S16 in FIG. 4.

### (7) Constraint Relaxation Comparison Screen Image

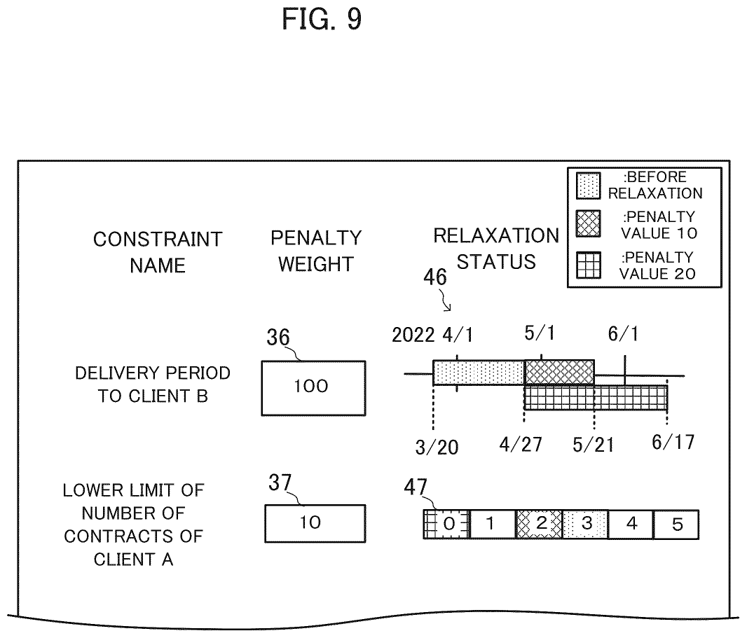

Next, a concrete description will be given of the constraint relaxation status comparison screen image displayed by the second display control unit 163. FIG. 9 shows a display example of the constraint relaxation status comparison screen image. The second display control unit 163 transmits the display information S2 for displaying the constraint relaxation status comparison screen image to the display device 3 via the interface 13 to cause the display device 3 to display the constraint relaxation status comparison screen image.

The second display control unit 163 identifies the relaxed constraint conditions in the two solutions (in this case, the solution for the penalty value “10” and the solution for the penalty value “20”) specified in the penalty value/objective function value relation screen image. Then, for each of the relaxed constraint conditions, the second display control unit 163 displays the relaxation status of each constraint condition and the penalty weights corresponding to the two solutions in a comparable way, on the constraint relaxation status comparison screen image. For example, it is shown that the penalty weight for the constraint condition “delivery period to client B” is set to “100” in penalty weight display field 36, and, in the graph 46, the relaxation status at each solution is displayed by color coding together with its initial range. Here, in the solution for the penalty value “10”, the end point of the constraint condition “delivery period to client B” was extended (relaxed) until May 21, and in the solution for the penalty value “20”, the end point of the constraint condition “delivery period to client B” is extended (relaxed) until June 17.

Similarly, it is shown that the penalty weight for the constraint condition “lower limit of the number of contracts of client A” is set to “10” in the penalty weight display field 37, and in the graph 47, the relaxation status of each solution is displayed by color coding together with the initial range. In this example, the lower limit of the number of contracts of the client A is lowered (eased) to “2” in the solution for the penalty value “10”, and the lower limit of the number of contracts of the client A is lowered (eased) to “0” in the solution for the penalty value “20”. In the same way, on the constraint relaxation status comparison screen image, the second display control unit 163 may display information as to whether or not to omit each target constraint condition (see FIG. 6B), which is subject to designation regarding the necessity of exclusion, in association with each solution.

### Second Example Embodiment

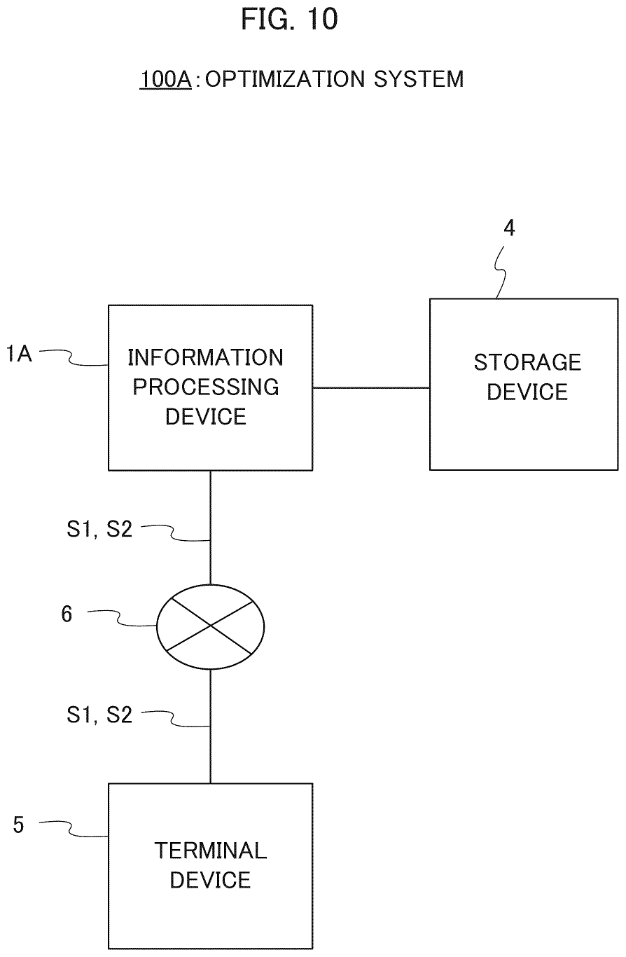

FIG. 10 shows the configuration of the optimization system 100A in the second example embodiment. As shown in FIG. 10, the optimization system 100A mainly includes an information processing device 1A, a storage device 4, and a terminal device 5. The information processing device 1A and the terminal device 5 perform data communication with each other via the network 6.

The information processing device 1A has the same configuration as the information processing device 1 according to the first example embodiment and executes the same optimization process as the information processing device 1. In this instance, the information processing device 1A receives the input information S1, which the information processing device 1 receives from the input device 2 in the first example embodiment, from the terminal device 5 via the network 6. Further, the information processing device 1A transmits the display information S2, which the information processing device 1 transmits to the display device 3 in the first example embodiment, via the network 6 to the terminal device 5. As such, the information processing device 1A according to the second example embodiment functions as a server device.

The terminal device 5 is a terminal equipped with an input function, a display function, and a communication function, and functions as the input device 2 and the display device 3 in the first example embodiment. The terminal device 5 may be, for example, a personal computer, a tablet-type terminal, a PDA (Personal Digital Assistant), or the like. The terminal device 5 transmits the input information ST generated based on the received user input to the information processing device 1A through the network 6. Upon receiving the display information S2 from the information processing device 1A, the terminal device 5 displays various screen images based on the display information S2.

The information processing device 1A according to the second example embodiment can suitably execute the input processing and the display processing, which are executed by the information processing device 1 in the first example embodiment, for the user of the terminal device 5.

### Third Example Embodiment

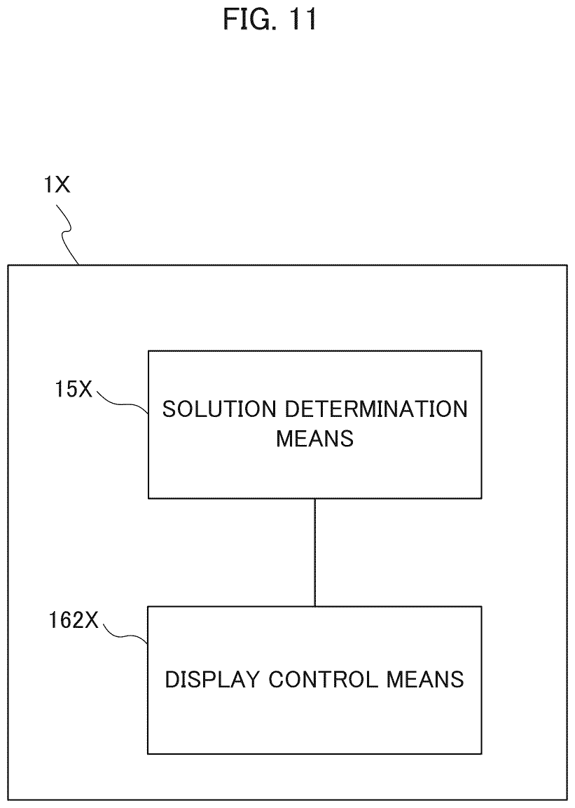

FIG. 11 is a functional block diagram of an information processing device 1X according to a third example embodiment. The information processing device 1X mainly includes a solution determination means 15X and a display control means 162X. The information processing device 1X may be configured by a plurality of devices.

The solution determination means 15 is configured to determine, based on condition information regarding conditions of an optimization problem and constraint relaxation information regarding a relaxation of a constraint condition, a solution of the optimization problem in accordance with a degree of the relaxation of the constraint condition. Examples of the solution determination means 15X include the solution determination unit 15 according to the first example embodiment or the second example embodiment.

The display control means 162X is configured to display, on a display device, relation information indicating a relation between the degree of the relaxation of the constraint condition and an objective function value of the solution corresponding to the degree of the relaxation. The display device may be a device (e.g., the display device 3 or the terminal device 5) separate from the information processing device 1X, or may be incorporated in the information processing device 1X. Examples of the display control means 162X include the first display control unit 162 in the first example embodiment or the second example embodiment.

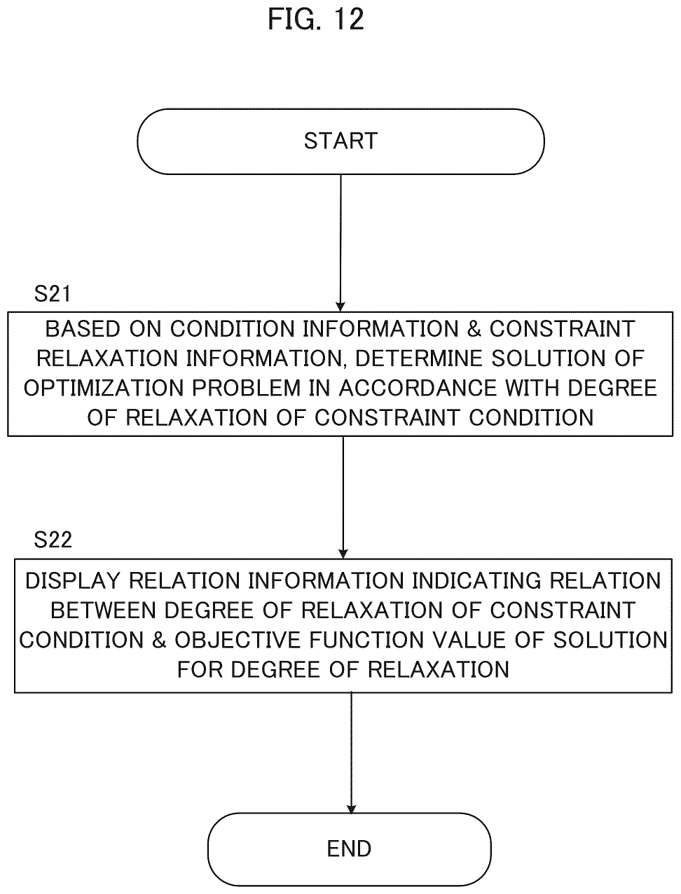

FIG. 12 is an exemplary flowchart that is executed by the information processing device 1X in the third example embodiment. First, the solution determination means 15 is configured to determine, based on condition information regarding conditions of an optimization problem and constraint relaxation information regarding a relaxation of a constraint condition, a solution of the optimization problem in accordance with a degree of the relaxation of the constraint condition (step S21). Then, the display control means 162X displays, on a display device, relation information indicating a relation between the degree of the relaxation of the constraint condition and an objective function value of the solution corresponding to the degree of the relaxation (step S22).

The information processing device 1X according to the third example embodiment can suitably visualize the relation between the degree of relaxation of the constraint condition and the objective function value.

The whole or a part of the example embodiments described above (including modifications, the same applies hereinafter) can be described as, but not limited to, the following Supplementary Notes.

### [Supplementary Note 1]

An information processing device comprising:
a solution determination means configured to determine, based on condition information regarding conditions of an optimization problem and constraint relaxation information regarding a relaxation of a constraint condition, a solution of the optimization problem in accordance with a degree of the relaxation of the constraint condition; and
a display control means configured to display, on a display device, relation information indicating a relation between the degree of the relaxation of the constraint condition and an objective function value of the solution corresponding to the degree of the relaxation.

### [Supplementary Note 2]

The information processing device according to Supplementary Note 1,
wherein the constraint relaxation information includes
   a type of the constraint condition the relaxation of which is acceptable,
   a relaxation range of the constraint condition, and
   a weight for a penalty when the constraint condition is relaxed, and
wherein the degree of the relaxation is determined based on the weight for the constraint condition relaxed in the solution.

### [Supplementary Note 3]

The information processing device according to Supplementary Note 2, further comprising
a constraint relaxation designation means is configured to receive a designation regarding
   the type of the constraint condition,
   the relaxation range of the constraint condition, and
   the weight for the penalty when the constraint condition is relaxed.

### [Supplementary Note 4]

The information processing device according to Supplementary Note 2 or 3,
wherein the solution determination means is configured to calculate, based on the weight for each constraint condition relaxed in the solution, a penalty value which is an index value representing the degree of the relaxation, and
wherein the display control means is configured to display, on the display device, the relation information indicating a relation between the penalty value and the objective function value of the solution for the penalty value.

### [Supplementary Note 5]

The information processing device according to Supplementary Note 4,
wherein the solution determination means is configured to calculate the penalty value based on
   the weight for each constraint condition relaxed in the solution and
   a degree of deviation from the constraint condition before the relaxation.

### [Supplementary Note 6]

The information processing device according to any one of Supplementary Notes 1 to 5,
wherein the display control means is configured to display, on the display device, information for comparing relaxation statuses of the constraint condition relaxed in the solutions corresponding to at least two of the degree of the relaxation.

### [Supplementary Note 7]

The information processing device according to Supplementary Note 6,
wherein the display control means is configured to receive, on a display screen image based on the relation information, an input which specifies the at least two of the degree of the relaxation.

### [Supplementary Note 8]

The information processing device according to any one of Supplementary Notes 1 to 7,
wherein the display control means is configured to display, on the display device, a table or a graph indicating the relation as the relationship information.

### [Supplementary Note 9]

A control method executed by a computer, the control method comprising:
determining, based on condition information regarding conditions of an optimization problem and constraint relaxation information regarding a relaxation of a constraint condition, a solution of the optimization problem in accordance with a degree of the relaxation of the constraint condition; and
displaying, on a display device, relation information indicating a relation between the degree of the relaxation of the constraint condition and an objective function value of the solution corresponding to the degree of the relaxation.

### [Supplementary Note 10]

A storage medium storing a program executed by a computer, the program causing the computer to:
determine, based on condition information regarding conditions of an optimization problem and constraint relaxation information regarding a relaxation of a constraint condition, a solution of the optimization problem in accordance with a degree of the relaxation of the constraint condition; and
display, on a display device, relation information indicating a relation between the degree of the relaxation of the constraint condition and an objective function value of the solution corresponding to the degree of the relaxation.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All patent and Non-Patent Literatures mentioned in this specification are incorporated by reference in its entirety.

### DESCRIPTION OF REFERENCE NUMERALS

1, 1A, 1X Information processing device
2 Input device
3 Display device
4 Storage device
5 Terminal device
100 and 100A Optimization system

What is claimed is:

1. An information processing device comprising:
at least one memory configured to store instructions; and
at least one processor configured to execute the instructions to:
determine, based on condition information regarding conditions of an optimization problem and constraint relaxation information regarding a relaxation of a constraint condition, a solution of the optimization problem in accordance with a degree of the relaxation of the constraint condition; and
display, on a display device, relation information indicating a relation between the degree of the relaxation of the constraint condition and an objective function value of the solution corresponding to the degree of the relaxation.

2. The information processing device according to claim 1,
wherein the constraint relaxation information includes
a type of the constraint condition the relaxation of which is acceptable,
a relaxation range of the constraint condition, and
a weight for a penalty when the constraint condition is relaxed, and
wherein the degree of the relaxation is determined based on the weight for the constraint condition relaxed in the solution.

3. The information processing device according to claim 2,
wherein the at least one processor is configured to further execute the instructions to receive a designation regarding
the type of the constraint condition,
the relaxation range of the constraint condition, and
the weight for the penalty when the constraint condition is relaxed.

4. The information processing device according to claim 2,
wherein the at least one processor is configured to execute the instructions to calculate, based on the weight for each constraint condition relaxed in the solution, a penalty value which is an index value representing the degree of the relaxation, and
wherein the at least one processor is configured to execute the instructions to display, on the display device, the relation information indicating a relation between the penalty value and the objective function value of the solution for the penalty value.

5. The information processing device according to claim 4,
wherein the at least one processor is configured to execute the instructions to calculate the penalty value based on the weight for each constraint condition relaxed in the solution and a degree of deviation from the constraint condition before the relaxation.

6. The information processing device according to claim 1,
wherein the at least one processor is configured to execute the instructions to display, on the display device, information for comparing relaxation statuses of the constraint condition relaxed in the solution corresponding to at least two of the degree of the relaxation.

7. The information processing device according to claim 6,
wherein the at least one processor is configured to execute the instructions to receive, on a display screen image based on the relation information, an input which specifies the at least two of the degree of the relaxation.

8. The information processing device according to claim 1,
wherein the at least one processor is configured to execute the instructions to display, on the display device, a table or a graph indicating the relation as the relationship information.

9. A control method executed by a computer, the control method comprising:
determining, based on condition information regarding conditions of an optimization problem and constraint relaxation information regarding a relaxation of a constraint condition, a solution of the optimization problem in accordance with a degree of the relaxation of the constraint condition; and
displaying, on a display device, relation information indicating a relation between the degree of the relaxation of the constraint condition and an objective function value of the solution corresponding to the degree of the relaxation.

10. A non-transitory computer readable storage medium storing a program executed by a computer, the program causing the computer to:
determine, based on condition information regarding conditions of an optimization problem and constraint relaxation information regarding a relaxation of a constraint condition, a solution of the optimization problem in accordance with a degree of the relaxation of the constraint condition; and
display, on a display device, relation information indicating a relation between the degree of the relaxation of the constraint condition and an objective function value of the solution corresponding to the degree of the relaxation.
